(19) United States
(12) Patent Application Publication
(10) Pub. No.: US 2026/0178331 A1
(43) Pub. Date: Jun. 25, 2026

(54) PROCESSOR FOR PERFORMING FLOW CONTROL OF MULTIPLE TYPES OF INSTRUCTIONS AND METHOD FOR PERFORMING FLOW CONTROL OF MULTIPLE TYPES OF INSTRUCTIONS IN PROCESSOR

(71) Applicant: MEDIATEK INC., Hsinchu City (TW)

(72) Inventors: Yu-Kuang Tu, Hsinchu City (TW); Kuo-Hsing Juan, Hsinchu City (TW); Tsung-Hua Hsueh, Hsinchu City (TW); Po-Chun Fan, Hsinchu City (TW)

(73) Assignee: MEDIATEK INC., Hsinchu City (TW)

(21) Appl. No.: 18/988,855

(22) Filed: Dec. 19, 2024

(51) Int. Cl. G06F 9/30; G06F 9/38

(52) U.S. Cl. CPC G06F 9/3005; G06F 9/3869

(57) ABSTRACT

A processor and a method for performing flow control of multiple types of instructions are provided. The processor includes a first pipeline processing circuit, a second pipeline processing circuit, a first flow control unit and a second flow control unit. The first pipeline processing circuit receives the multiple types of instructions from outside of the processor and handles a first-type instruction. The second pipeline processing circuit receives the multiple types of instructions from the first pipeline processing circuit and handles a second-type instruction. The first flow control unit and the second flow control unit receives a third-type instruction from the first pipeline processing circuit and the second pipeline processing circuit, respectively, for generating control information according to the third-type instruction. The first pipeline processing circuit and the second pipeline processing circuit obtain the control information from the first flow control unit and the second flow control unit, respectively.

### BACKGROUND

The present invention is related to instruction processors, and more particularly, to a processor for performing flow control of multiple types of instructions and a method for performing the flow control of the multiple types of instructions in the processor.

An instruction processor may utilize multiple partial circuits to respectively execute different types of instructions in an instruction packet. For example, execution of these partial circuits regarding this instruction packet may be arranged in a serial manner, and latency of data or instructions between these partial circuits may exist. However, execution results of a specific type of instructions may be required when performing predication of two or more other types of instructions. Thus, when utilizing a single hardware for storing and providing execution results to all processors which perform the predication of the aforementioned two or more other types of instructions, the latency of data or instructions between different partial circuits mentioned above may affect an overall efficiency of handling the instruction packet.

Thus, there is a need for a novel architecture of the instruction processor and an associated method, in order to improve the performance of handling the instruction packet which comprising multiple types of instructions.

### SUMMARY

An objective of the present invention is to provide a processor for performing flow control of multiple types of instructions and a method for performing the flow control of the multiple types of instructions in the processor, in order to improve performance of an instruction processor without introducing any side effect or in a way that is less likely to introduce side effects.

At least one embodiment of the present invention provides a processor for performing flow control of multiple types of instructions. The processor comprises a first pipeline processing circuit, a second pipeline processing circuit, a first flow control unit and a second flow control unit, wherein the second pipeline processing circuit is coupled to the first pipeline processing circuit, the first flow control unit is coupled to the first pipeline processing circuit, and the second flow control unit is coupled to the second pipeline processing circuit. The first pipeline processing circuit is configured to receive the multiple types of instructions from outside of the processor and handle a first-type instruction among the multiple types of instructions. The second pipeline processing circuit is configured to receive the multiple types of instructions from the first pipeline processing circuit and handle a second-type instruction among the multiple types of instructions. The first flow control unit is configured to receive a third-type instruction among the multiple types of instructions from the first pipeline processing circuit and generate control information according to the third-type instruction. The second flow control unit is configured to receive the third-type instruction from the second pipeline processing circuit and generate the control information according to the third-type instruction. More particularly, the first pipeline processing circuit obtains the control information from the first flow control unit, and the second pipeline processing circuit obtains the control information from the second flow control unit, wherein the control information generated by the first flow control unit is identical to the control information generated by the second flow control unit.

At least one embodiment of the present invention provides a method for performing flow control of multiple types of instructions in a processor. The method comprises: utilizing a first pipeline processing circuit of the processor to receive the multiple types of instructions from outside of the processor and handle a first-type instruction among the multiple types of instructions; utilizing a second pipeline processing circuit of the processor to receive the multiple types of instructions from the first pipeline processing circuit and handle a second-type instruction among the multiple types of instructions; utilizing a first flow control unit of the processor to receive a third-type instruction among the multiple types of instructions from the first pipeline processing circuit and generate control information according to the third-type instruction; utilizing a second flow control unit of the processor to receive the third-type instruction from the second pipeline processing circuit and generate the control information according to the third-type instruction; utilizing the first pipeline processing circuit to obtain the control information from the first flow control unit; and utilizing the second pipeline processing circuit to obtain the control information from the second flow control unit. More particularly, the control information generated by the first flow control unit is identical to the control information generated by the second flow control unit.

The processor and the method provided by the embodiments of the present invention can utilize multiple flow control units to provide control information to multiple pipeline processing circuits within the processor, respectively, in order to prevent or reduce transaction(s) of the control information between the multiple pipeline processing circuits. Thus, the latency between the multiple pipeline processing circuits is less likely to affect an overall performance of the instruction processor.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a processor according to an embodiment of the present invention.

FIG. 2 is a diagram illustrating a vector processor according to an embodiment of the present invention.

FIG. 3 is a diagram illustrating a working flow of a method for performing flow control of multiple types of instruction in a processor according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to ...”. Also, the term “couple” is intended to mean either an indirect or direct electrical connection. Accordingly, if one device is coupled to another device, that connection may be through a direct electrical connection, or through an indirect electrical connection via other devices and connections.

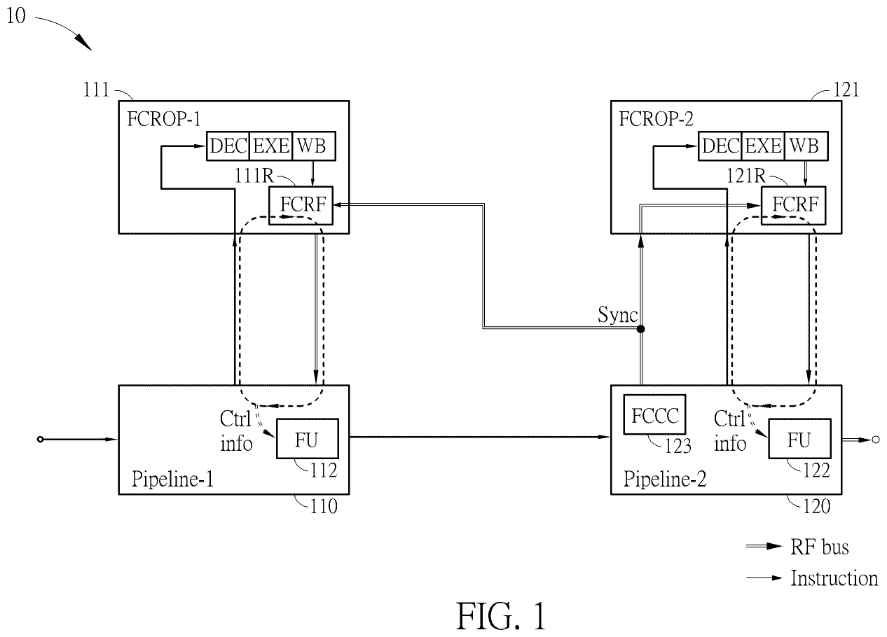

FIG. 1 is a diagram illustrating a processor such as an instruction processor 10 according to an embodiment of the present invention. As shown in FIG. 1, the instruction processor 10 may comprise a first pipeline processing circuit 110 (labeled “Pipeline-1” in FIG. 1 for brevity), a second pipeline processing circuit 120 (labeled “Pipeline-2” in FIG. 1 for brevity), a first flow control unit such as a first flow control operating circuit 111 (labeled “FCROR-1” in FIG. 1 for brevity) and a second flow control unit such as a second flow control operating circuit 121 (labeled “FCROR-2” in FIG. 1 for brevity), where the second pipeline processing circuit 120 is coupled to the first pipeline processing circuit 110, the first flow control operating circuit 111 is coupled to the first pipeline processing circuit 110, and the second flow control operating circuit 121 is coupled to the second pipeline processing circuit 120. For better comprehension, transmission of an instruction or an instruction packet is illustrated by arrows as shown by a legend “Instruction” in FIG. 1, and transmission of data or information stored in register file(s) is illustrated by arrows as shown by a legend “RF bus” in FIG. 1.

In this embodiment, the first pipeline processing circuit 110 is configured to receive an instruction packet (which comprises multiple types of instructions) from outside of the instruction processor 10, where the first pipeline processing circuit 110 may handle a first-type instruction (e.g. by a functional unit 112 therein which is labeled “FU” in FIG. 1 for brevity) among the multiple types of instructions. The second pipeline processing circuit 120 is configured to receive the instruction packet (e.g. the multiple types of instructions) from the first pipeline processing circuit 110, where the second pipeline processing circuit 120 may handle a second-type instruction (e.g. by a functional unit 122 therein which is labeled “FU” in FIG. 1 for brevity) among the multiple types of instructions. The first flow control operating circuit 111 is configured to receive a third-type instruction among the multiple types of instructions from the first pipeline processing circuit 110 and generate control information according to the third-type instruction. The second flow control operating circuit 121 is configured to receive the third-type instruction from the second pipeline processing circuit 120 and generate the control information according to the third-type instruction. More particularly, the first pipeline processing circuit 110 may obtain the control information from the first flow control operating circuit 111, and the second pipeline processing circuit 120 may obtain the control information from the second flow control operating circuit 121, wherein the control information generated by the first flow control operating circuit 111 is identical to the control information generated by the second flow control operating circuit 121. For example, when the functional unit 112 needs the control information generated based on the third-type instruction for performing predication of the first-type instruction, the functional unit 112 may obtain the control information from the first flow control operating circuit 111 (as illustrated by a dashed arrow labeled “Ctrl info” in the first pipeline processing circuit 110); and when the functional unit 122 needs the control information generated based on the third-type instruction for performing predication of the second-type instruction, the functional unit 112 may obtain the control information from the second flow control operating circuit 121(as illustrated by a dashed arrow labeled “Ctrl info” in the second pipeline processing circuit 120).

In this embodiment, the first pipeline processing circuit 110 and the first flow control operating circuit 111 may belong to a first portion of the instruction processor 10, and the second pipeline processing circuit 120 and the second flow control operating circuit 121 may belong to a second portion of the instruction processor 10, where transactions between the first portion and the second portion of the instruction processor 10 has latency which may affect an overall performance of the instruction processor 10. For example, the first pipeline processing circuit 110 obtaining the control information from the first flow control operating circuit 111 is faster than the first pipeline processing circuit 110 obtaining the control information from the second flow control operating circuit 121, and the second pipeline processing circuit 120 obtaining the control information from the second flow control operating circuit 121 is faster than the second pipeline processing circuit 120 obtaining the control information from the first flow control operating circuit 111. Thus, in comparison with utilizing a single flow control operating circuit for providing the control information to both the first pipeline processing circuit 110 and the second pipeline processing circuit 120, utilizing the first flow control operating circuit 111 and the second flow control operating circuit 121 respectively dedicated for providing the control information to the first pipeline processing circuit 110 and the second pipeline processing circuit 120 can greatly improve an overall performance of the instruction processor 10.

In detail, the first flow control operating circuit 111 may comprise a first register file such as a flow control register file 111R (labeled “FCRF” in FIG. 1 for brevity) to store the control information generated by the first flow control operating unit, and the second flow control operating circuit may comprise a second register file such as a flow control register file 121R to store the control information generated by the second flow control operating circuit 121, where each of the flow control register files 111R and 121R may be regarded as a group of registers. When the first pipeline processing circuit 110 detects that the third-type instruction is included in the instruction packet, the first pipeline processing circuit 110 may send the third-type instruction to the first flow control operating circuit 111, where the first flow control operating circuit 111 may handle the third-type instruction based on a pipeline architecture to generate the control information to the flow control register file 111R according to the third-type instruction, by decoding (as illustrated by an operation labeled “DEC” in the first flow control operating circuit 111) and executing (as illustrated by an operation labeled “EXE” in the first flow control operating circuit 111) the third-type instruction to generate the control information to be written back (as illustrated by an operation labeled “WB” in the first flow control operating circuit 111) to the flow control register file 111R. When the second pipeline processing circuit 120 detects that the third-type instruction is included in the instruction packet, the second pipeline processing circuit 120 may send the third-type instruction to the second flow control operating circuit 121, where the second flow control operating circuit 121 may handle the third-type instruction based on a pipeline architecture to generate the control information to the flow control register file 121R according to the third-type instruction, by decoding (as illustrated by an operation labeled “DEC” in the second flow control operating circuit 121) and executing (as illustrated by an operation labeled “EXE” in the second flow control operating circuit 121) the third-type instruction to generate the control information to be written back (as illustrated by an operation labeled “WB” in the second flow control operating circuit 121) to the flow control register file 121R. In some embodiment, the first flow control operating circuit 111 may be a part of the first pipeline processing circuit 110, and the second flow control operating circuit 121 may be a part of the second pipeline processing circuit 120, but the present invention is not limited thereto.

In this embodiment, the second-type instruction may comprise a condition checking instruction, and the second pipeline processing circuit 120 may comprise a condition checking circuit such as a flow control condition checking circuit 123 (labeled “FCCC” in FIG. 1 for brevity). The flow control condition checking circuit 123 is configured to generate condition checking information according to the condition checking instruction. The second pipeline processing circuit 120 may write the condition checking information into both the flow control register files 111R and 121R to make information stored in the flow control register file 111R be identical to information stored in the flow control register file 121R. For example, the functional unit 112 may need the condition checking information generated by the flow control condition checking circuit 123 in some conditions. In order to ensure that the first pipeline processing circuit 110 can obtain the condition checking information without the latency between the first portion and the second portion of the instruction processor 10 mentioned above when needed, the second pipeline processing circuit 120 may synchronize the information stored in the flow control register files 111R and 121R (labeled “Sync” in FIG. 1 for brevity) when the condition checking information is generated.

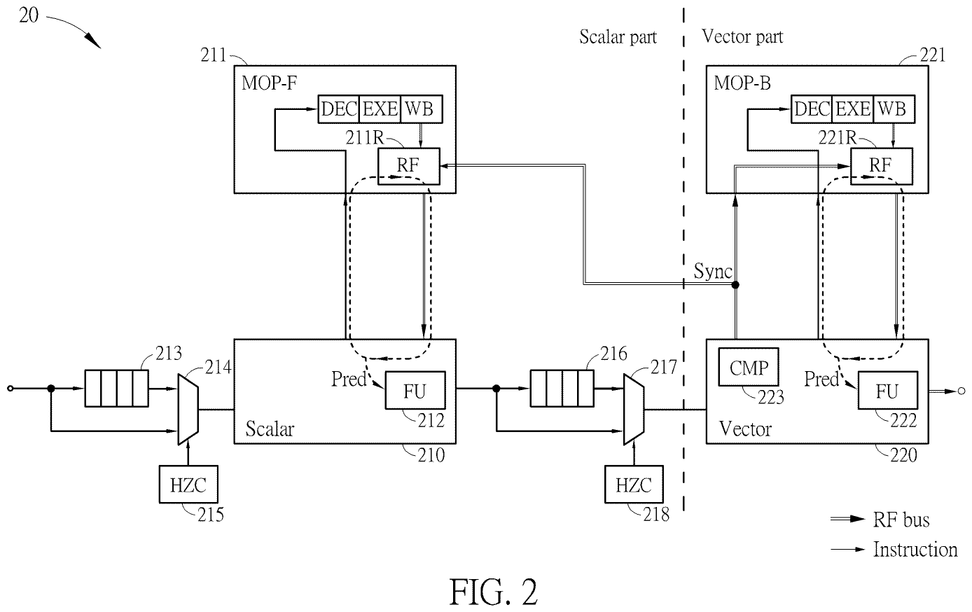

FIG. 2 is a diagram illustrating a vector processor 20 according to an embodiment of the present invention, where the vector processor 20 may be an example of the instruction processor 10 shown in FIG. 1. The vector processor 20 is configured to handle multiple types of instructions such as vector instructions, scalar instructions and mask operation (MOP) instructions, where each of the scalar instructions may be an example of the first-type instruction mentioned above, each of the scalar instructions may be an example of the second-type instruction mentioned above, and each of the MOP instructions may be an example of the third-type instruction mentioned above. As shown in FIG. 2, the vector processor 20 may comprise a scalar processing circuit such as a scalar engine 210 (labeled “Scalar” in FIG. 2 for brevity), a vector processing circuit such as a vector engine 220 (labeled “Vector” in FIG. 2 for brevity), an MOP-frontend circuit 211 (labeled “MOP-F” in FIG. 2 for brevity) and an MOP-backend circuit 221 (labeled “MOP-B” in FIG. 2 for brevity). For better comprehension, transmission of an instruction or an instruction packet is illustrated by arrows as shown by a legend “Instruction” in FIG. 2, and transmission of data or information stored in register file(s) is illustrated by arrows as shown by a legend “RF bus” in FIG. 1. In this embodiment, the scalar engine 210, the vector engine 220, the MOP-frontend circuit 211 and the MOP-backend circuit 221 may be examples of the firs pipeline processing circuit 110, the second pipeline processing circuit 120, the first flow control operating circuit 111 and the second flow control operating circuit 121, respectively. Thus, those skilled in this art can understand related operations of the scalar engine 210, the vector engine 220, the MOP-frontend circuit 211, the MOP-backend circuit 221 and circuit block therein such as register files 211R and 221R (labeled “RF” in FIG. 2 for brevity) and functional units 211 and 222 (labeled “FU” in FIG. 2 for brevity) by referring to the embodiment of FIG. 1.

In this embodiment, the scalar engine 210 (e.g. the functional unit 212 therein) may utilize the control information generated by the MOP-frontend circuit 211 (e.g. the control information stored in the register file 211R) for predication of the scalar instruction, and the vector engine 220 (e.g. functional unit 222 therein) may utilize the control information generated by the MOP-backend circuit 221 (e.g. e.g. the control information stored in the register file 221R) for predication of the vector instruction.

In this embodiment, the scalar engine 210 and the MOP-frontend circuit 211 may belong to a scalar part of the vector processor 20, and the vector engine 220 and the MOP-backend circuit 221 may belong to a vector part of the vector processor 20, where transactions between the scalar part and the vector part of the vector processor 20 has latency which may affect an overall performance of the vector processor 10. Similar to the concept mentioned in the embodiment of FIG. 1, in comparison with utilizing a single MOP circuit for providing the control information to both the scalar engine 210 and the vector engine 220, utilizing the MOP-frontend circuit 211 and the MOP backend circuit 221 respectively dedicated for providing the control information to the scalar engine 210 and the vector engine 220 can greatly improve an overall performance of the vector processor 20.

In addition, a comparing instruction among the multiple types of instructions may be implemented with a vector instruction such as a vector comparing instruction. Thus, the vector engine 220 may comprise a vector comparator 223 (labeled “CMP” in FIG. 2 for brevity), which may be an example of the flow control condition checking circuit 123 of the instruction processor 10. The vector comparator 223 is configured to generate a vector comparison result according to the vector comparing instruction, where the vector comparison result is transmitted to both the MOP-frontend circuit 211 and the MOP-backend circuit 221 for updating the control information of the MOP-frontend circuit 211 and the control information of the MOP-backend circuit 221, in order to make the control information from the MOP-frontend circuit 211 be identical to the control information from the MOP-backend circuit 221. Similar to the concept mentioned in the embodiment of FIG. 1, the vector comparison result corresponding to the vector comparing instruction may be required when performing the dedication of the scalar instruction in some conditions, and the functional unit 212 may obtain the vector comparison result from the register file 211R without suffering the latency between the scalar part and the vector part of the vector processor 20 when needed, as the vector engine 220 may synchronize the information stored in the register files 211R and 221R (labeled “Sync” in FIG. 2 for brevity) when the vector comparison result is generated.

In this embodiment, the vector processor 20 may further comprise at least one buffer such as a first in first out (FIFO) buffer 213, a multiplexer (MUX) 214 and a hazard control (HZC) logic 215 (labeled “HZC” in FIG. 2 for brevity), where the FIFO buffer 213 may be coupled to an input end of the scalar engine 210 via the MUX 214, and the scalar engine 210 may receive the instruction packet (e.g. the multiple types of instructions) from outside of the vector processor 20 by queuing the multiple types of instructions in the FIFO buffer 213 when any operand hazard occurs. For example, when the HZC logic 215 determines that operand hazard occurs in operations of the scalar engine 210, the HZC logic 215 may control the MUX 214 to enable an upper terminal thereof to make the instruction packet be transmitted to the scalar engine 210 via the FIFO buffer 213, in order to prevent the instruction packet from being stalled at input of the vector processor 20 (e.g. preventing a condition where the vector processor 20 is unable to receive subsequent instructions). If the HZC logic 215 determines that no operand hazard occurs and the FIFO buffer 213 is empty (e.g. no instruction is queued therein), the HZC logic 215 may control the MUX 214 to enable a lower terminal thereof to make the instruction packet be transmitted to the scalar engine 210 via a bypass path without being queued in the FIFO buffer 213, but the present invention is not limited thereto. In this embodiment, the FIFO 213, the MUX 214 and the HZC logic 215 may belong to the scalar part of the vector processor 20, but the present invention is not limited thereto. In some embodiment, the FIFO 213, the MUX 214 and the HZC logic 215 may be part of the scalar engine 210, but the present invention is not limited thereto.

In this embodiment, the vector processor 20 may further comprise at least one buffer such as a FIFO buffer 216, a MUX 217 and a HZC logic 218 (labeled “HZC” in FIG. 2 for brevity), where the FIFO buffer 216 may be coupled to an output end of the scalar engine 210 and an input end of the vector engine 220 via the MUX 217, and the scalar engine 210 may transmit the instruction packet (e.g. the multiple types of instructions) to the vector engine 220 by queuing the multiple types of instructions in the FIFO buffer 216 when any operand hazard occurs. For example, when the HZC logic 218 determines or predicts that operand hazard occurs in operations of the vector engine 220, the HZC logic 218 may control the MUX 217 to enable an upper terminal thereof to make the instruction packet be transmitted to the vector engine 220 via the FIFO buffer 216, which provides a temporary storage space for the instruction packet. If the HZC logic 218 determines or predicts that no operand hazard occurs (e.g. determining or predicting that the vector engine 220 is ready to handle subsequent instructions) and the FIFO buffer 216 is empty (e.g. no instruction is queued therein), the HZC logic 218 may control the MUX 217 to enable a lower terminal thereof to make the instruction packet be transmitted to the vector engine 220 via a bypass path without being queued in the FIFO buffer 216, but the present invention is not limited thereto. In this embodiment, the FIFO 216, the MUX 217 and the HZC logic 218 may belong to the scalar part of the vector processor 20, but the present invention is not limited thereto. In some embodiment, the FIFO 216, the MUX 217 and the HZC logic 218 may be part of the vector engine 220, but the present invention is not limited thereto.

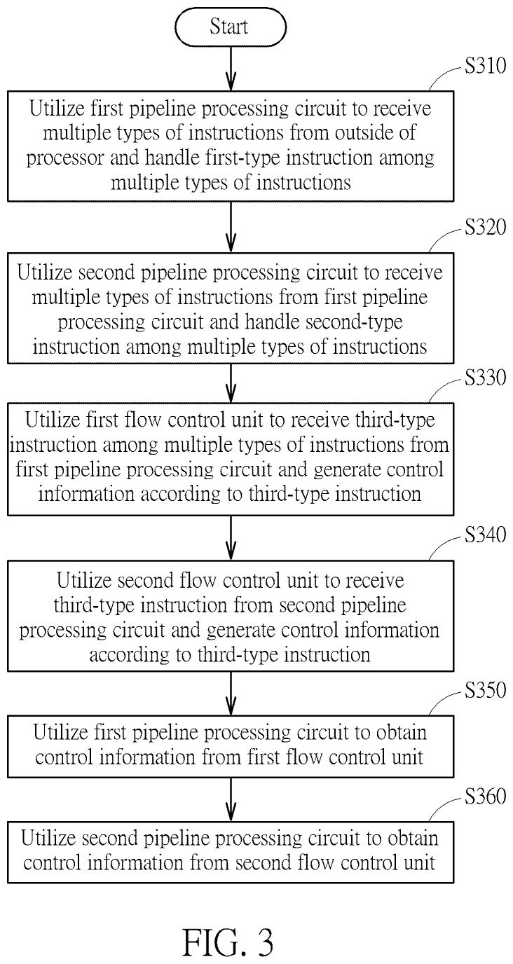

FIG. 3 is a diagram illustrating a working flow of a method for performing flow control of multiple types of instruction in a processor (e.g. the instruction processor 10 shown in FIG. 1 and the vector processor 20 shown in FIG. 2) according to an embodiment of the present invention. It should be noted that the working flow shown in FIG. 3 is for illustrative purposes only, and is not meant to be a limitation of the present invention. For example, one or more steps may be added, deleted or modified in the working flow shown in FIG. 3. In addition, if a same result can be obtained, these steps do not have to be executed in the exact order shown in FIG. 3.

In Step S310, the processor may utilize a first pipeline processing circuit thereof to receive the multiple types of instructions from outside of the processor and handle a first-type instruction among the multiple types of instructions.

In Step S320, the processor may utilize a second pipeline processing circuit thereof to receive the multiple types of instructions from the first pipeline processing circuit and handle a second-type instruction among the multiple types of instructions.

In Step S330, the processor may utilize a first flow control unit thereof to receive a third-type instruction among the multiple types of instructions from the first pipeline processing circuit and generate control information according to the third-type instruction.

In Step S340, the processor may utilize a second flow control unit thereof to receive the third-type instruction from the second pipeline processing circuit and generate the control information according to the third-type instruction.

In Step S350, the processor may utilize the first pipeline processing circuit to obtain the control information from the first flow control unit.

In Step S360, the processor may utilize the second pipeline processing circuit to obtain the control information from the second flow control unit.

To summarize, the processor (e.g. the instruction processor 10 shown in FIG. 1 and the vector processor 20 shown in FIG. 2) and the method provided by the embodiments of the present invention can utilize dedicated flow control units (e.g. separated register files therein) for providing the same control information to different pipeline processing circuits, in order to prevent the latency between these pipeline processing circuits from affecting an overall performance of the processor. In addition, the embodiments of the present invention will not greatly increase additional costs. Thus, the present invention can solve the problem of the related art without introducing any side effect or in a way that is less likely to introduce side effects.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A processor for performing flow control of multiple types of instructions, comprising:
a first pipeline processing circuit, configured to receive the multiple types of instructions from outside of the processor and handle a first-type instruction among the multiple types of instructions;
a second pipeline processing circuit, coupled to the first pipeline processing circuit, configured to receive the multiple types of instructions from the first pipeline processing circuit and handle a second-type instruction among the multiple types of instructions;
a first flow control unit, coupled to the first pipeline processing circuit, configured to receive a third-type instruction among the multiple types of instructions from the first pipeline processing circuit and generate control information according to the third-type instruction; and
a second flow control unit, coupled to the second pipeline processing circuit, configured to receive the third-type instruction from the second pipeline processing circuit and generate the control information according to the third-type instruction;
wherein the first pipeline processing circuit obtains the control information from the first flow control unit, the second pipeline processing circuit obtains the control information from the second flow control unit, and the control information generated by the first flow control unit is identical to the control information generated by the second flow control unit.

2. The processor of claim 1, wherein the first pipeline processing circuit obtaining the control information from the first flow control unit is faster than the first pipeline processing circuit obtaining the control information from the second flow control unit, and the second pipeline processing circuit obtaining the control information from the second flow control unit is faster than the second pipeline processing circuit obtaining the control information from the first flow control unit.

3. The processor of claim 1, wherein the first flow control unit comprises a first register file to store the control information generated by the first flow control unit, and the second flow control unit comprises a second register file to store the control information generated by the second flow control unit.

4. The processor of claim 3, wherein the second-type instruction comprises a condition checking instruction, and the second pipeline processing circuit comprises:
a condition checking circuit, configured to generate condition checking information according to the condition checking instruction;
wherein the condition checking information is written into both the first register file and the second register file to make information stored in the first register file be identical to information stored in the second register file.

5. The processor of claim 1, wherein at least one buffer is coupled to an input end of the first pipeline processing circuit, and the first pipeline processing circuit receives the multiple types of instructions from outside of the processor by queuing the multiple types of instructions in the at least one buffer when any operand hazard occurs.

6. The processor of claim 1, wherein at least one buffer is coupled between the first pipeline processing circuit and the second pipeline processing circuit, and the first pipeline processing circuit transmits the multiple types of instructions to the second pipeline processing circuit by queuing the multiple types of instructions in the at least one buffer when any operand hazard occurs.

7. The processor of claim 1, wherein the first pipeline processing circuit is a scalar processing circuit, the second pipeline processing circuit is a vector processing circuit, the first-type instruction is a scalar instruction, and the second-type instruction is a vector instruction.

8. The processor of claim 7, wherein the first flow control unit is a first mask operation circuit, the second flow control unit is a second mask operation circuit, the scalar processing circuit utilizes the control information for predication of the scalar instruction, and the vector processing circuit utilizes the control information for predication of the vector instruction.

9. The processor of claim 7, wherein the vector instruction comprises a vector comparing instruction, and the vector processing circuit comprises:
a vector comparator, configured to generate a vector comparison result according to the vector comparing instruction;
wherein the vector comparison result is transmitted to both the first mask operation circuit and the second mask operation circuit for updating the control information of the first mask operation circuit and the control information of the second mask operation circuit, in order to make the control information from the first mask operation circuit be identical to the control information from the second mask operation circuit.

10. A method for performing flow control of multiple types of instructions in a processor, comprising:
utilizing a first pipeline processing circuit of the processor to receive the multiple types of instructions from outside of the processor and handle a first-type instruction among the multiple types of instructions;
utilizing a second pipeline processing circuit of the processor to receive the multiple types of instructions from the first pipeline processing circuit and handle a second-type instruction among the multiple types of instructions;
utilizing a first flow control unit of the processor to receive a third-type instruction among the multiple types of instructions from the first pipeline processing circuit and generate control information according to the third-type instruction;
utilizing a second flow control unit of the processor to receive the third-type instruction from the second pipeline processing circuit and generate the control information according to the third-type instruction;
utilizing the first pipeline processing circuit to obtain the control information from the first flow control unit; and
utilizing the second pipeline processing circuit to obtain the control information from the second flow control unit;
wherein the control information generated by the first flow control unit is identical to the control information generated by the second flow control unit.

11. The method of claim 10, wherein the first pipeline processing circuit obtaining the control information from the first flow control unit is faster than the first pipeline processing circuit obtaining the control information from the second flow control unit, and the second pipeline processing circuit obtaining the control information from the second flow control unit is faster than the second pipeline processing circuit obtaining the control information from the first flow control unit.

12. The method of claim 10, further comprising:
utilizing a first register file of the first flow control unit to store the control information generated by the first flow control unit; and
utilizing a second register file of the second flow control unit to store the control information generated by the second flow control unit.

13. The method of claim 12, wherein the second-type instruction comprises a condition checking instruction, and the method further comprises:
utilizing a condition checking circuit of the second pipeline processing circuit to generate condition checking information according to the condition checking instruction; and
writing the condition checking information written into both the first register file and the second register file, to make information stored in the first register file be identical to information stored in the second register file.

14. The method of claim 10, wherein utilizing the first pipeline processing circuit of the processor to receive the multiple types of instructions from outside of the processor and handle the first-type instruction among the multiple types of instructions comprises:
receiving the multiple types of instructions from outside of the processor by queuing the multiple types of instructions in at least one buffer coupled to an input end of the first pipeline processing circuit in response to occurrence of any operand hazard.

15. The method of claim 10, wherein utilizing the second pipeline processing circuit of the processor to receive the multiple types of instructions from the first pipeline processing circuit and handle the second-type instruction among the multiple types of instructions comprises:
transmitting the multiple types of instructions to the second pipeline processing circuit from the first pipeline processing circuit by queuing the multiple types of instructions in at least one buffer coupled between the first pipeline processing circuit and the second pipeline processing circuit in response to occurrence of any operand hazard.

16. The method of claim 10, wherein the first pipeline processing circuit is a scalar processing circuit, the second pipeline processing circuit is a vector processing circuit, the first-type instruction is a scalar instruction, and the second-type instruction is a vector instruction.

17. The method of claim 16, wherein the first flow control unit is a first mask operation circuit, the second flow control unit is a second mask operation circuit, and the method further comprises:
utilizing the control information for predication of the scalar instruction by the scalar processing circuit; and
utilizing the control information for predication of the vector instruction by the vector processing circuit.

18. The method of claim 16, wherein the vector instruction comprises a vector comparing instruction, and the method further comprises:
utilizing a vector comparator of the vector processing circuit to generate a vector comparison result according to the vector comparing instruction; and
transmitting the vector comparison result to both the first mask operation circuit and the second mask operation circuit for updating the control information of the first mask operation circuit and the control information of the second mask operation circuit, in order to make the control information from the first mask operation circuit be identical to the control information from the second mask operation circuit.
